(19) United States
(12) Patent Application Publication
(10) Pub. No.: US 2004/0125924 A1
(43) Pub. Date: Jul. 1, 2004

(54) Provision of call destination information to a caller

(76) Inventors: William P. McMullin, Bedford (CA); Stephen Vaughan Murphy, Halifax (CA); Robert J. Devoto, Arlington, VA (US)

Correspondence Address: FISH & RICHARDSON P.C., 1425 K STREET, N.W., 11TH FLOOR, WASHINGTON, DC, 20005-3500, US

(21) Appl. No.: 10/334,145

(22) Filed: Dec. 31, 2002

(51) Int. Cl. H04M 1/64; H04M 3/42

(52) U.S. Cl. 379/88.19; 379/88.21; 379/207.02

(57) ABSTRACT

Providing call destination information to a caller includes receiving information related to a caller that uses a caller phone to make a call to a destination phone and receiving information related to a call recipient that uses the destination phone to receive the call. Call destination information is accessed based on both the information related to the caller and the information related to the call recipient. The caller is provided with access to the call destination information.

### TECHNICAL FIELD

This description relates to telecommunications systems, and more particularly to telecommunications systems used to provide information to a telephone caller.

### BACKGROUND

A telephone system sets up calls and supports the exchange of voice data between parties. The called party (“the call recipient”) and the calling party (“the caller”) typically use phones to exchange voice data over the telephone system. In addition to receiving voice data from the caller, the call recipient may receive information concerning the caller from the telephone system. For example, the call recipient may receive caller identity (ID) information from the telephone system prior to the call recipient answering the call.

### SUMMARY

In one general aspect, providing call destination information to a caller includes receiving information related to a caller that uses a caller phone to make a call to a destination phone and receiving information related to a call recipient that uses the destination phone to receive the call. Call destination information is accessed based on both the information related to the caller and the information related to the call recipient.

Implementations may include one or more of the following features. For example, the call destination information may be personalized to the caller based on information related to the caller, which may only be accessed for callers that have registered for a call destination information service. The call destination information may be personalized to the caller by including call destination information corresponding to a call destination service product chosen by the caller, or by providing the caller with access to call destination information that is personal to the caller or to an organization represented by the caller.

The information related to the call recipient may include a destination telephone number associated with the destination phone, information related to services provided to the call recipient or products sold to the call recipient, information designated by the call recipient as information that is available to the caller, and/or information related to the online status of the call recipient. The information related to the online status of the call recipient may include information related to the ability of the call recipient to receive instant messages and e-mails.

The information related to the caller may include a caller telephone number associated with the caller phone, which may be received from a telephone system or from a monitoring device coupled to the caller phone.

The call destination information may include information related to the geographic location of the destination phone, such as a map or directions from the caller to the call recipient and the weather or local news at the geographic location of the destination phone.

The call destination information may include information related to the call recipient, such as information related to a company represented by the call recipient such as stock quotes of the company or news related to the activities of the company.

The call destination information may include call recipient information that is proprietary to the caller or to a business or an organization related to the caller. The proprietary call recipient information may include proprietary address book information related to the call recipient, proprietary calendar information related to the call recipient, proprietary information related to business interactions between the call recipient and the caller or between the call recipient and a business or an organization associated with the caller, proprietary information related to products or services sold to the call recipient or sold to an organization or business associated with the call recipient, and information related to e-mails sent to the call recipient by the caller or received by the caller from the call recipient.

The call destination information may be sent to the caller as one or more digital communications accessible to the caller through a caller computer system. The digital communications may include e-mails or instant messages, which may be sent during or after the call. The digital communications may be accessible to the caller using a browser application.

The call destination information may be sent to the caller as data over the caller phone. The call destination information may be provided to the caller while the caller waits for a call recipient to pick up the destination phone or may be whispered to the caller during the call.

In another general aspect, a call destination information computer system for providing call destination information to a caller includes a call destination information computer and one or more call destination information data stores configured to store call destination information. The call destination information computer is configured to receive information related to a caller that uses a caller phone to make a call to a destination phone and receive information related to a call recipient that uses the destination phone to receive the call. The call destination computer also is configured to access call destination information from at least one of the call destination information data stores based on both the information related to the caller and the information related to the call recipient and provide the caller with access to the call destination information.

In another general aspect, a computer system includes a caller module and an information procurement module. The caller module is configured to discern among callers calling a destination based on caller-related information. The information procurement module is configured to provide a first discerned caller with access to a first set of call destination information and provide a second discerned caller with access to a second set of call destination information. The second set of call destination information is different than the first set of call destination information.

In another general aspect, providing call destination information includes discerning among callers calling a destination based on caller-related information. A first discerned caller is provided with access to a first set of call destination information. A second discerned caller is provided with access to a second set of call destination information. The first set of call destination information is different than the second set of call destination information.

The details of one or more implementations are set forth in the accompanying drawings and the description below. Other features will be apparent from the description and drawings, and from the claims.

### DESCRIPTION OF DRAWINGS

FIGS. 1 and 2 are block diagrams illustrating exemplary communications systems capable of providing call destination information to a caller.

FIG. 3 is a flow chart illustrating an exemplary process for providing call destination information to a caller.

Like reference symbols in the various drawings indicate like elements.

### DETAILED DESCRIPTION

A communications system may provide a caller with call destination information that is related to the call destination or the intended recipient, and which may be personalized for the caller. The communications system may include a telephone system, a call destination information system, one or more call destination information data stores, a caller phone, and a destination phone. The communications system also may include an instant messaging (IM) system, an e-mail system, a caller computer system, and a destination computer system communicating over a network.

When a caller initiates a call to a call recipient at a destination phone, the telephone network sets up the call, verifies whether the caller is registered to receive call destination information, and sends the destination telephone number and caller-related information to the call destination information system if the caller has registered to receive call destination information.

The call destination information system uses the destination telephone number and the caller-related information to access call destination information from one or more of the following sources: the telephone system, one or more call destination information data stores, the caller system, and other electronic communications systems and data networks (e.g., IM systems, e-mail systems, and the Internet). The call destination information data stores may include data stores that are internal to the call destination information system, data stores internal or accessible to the caller computer system, data stores integrated with or accessible to a computer system supporting the caller or the caller computer system (e.g., a business platform system supporting the caller computer system), and data stores that are part of computer systems of content providers otherwise unaffiliated with the call destination information service provider.

The call destination information system may be configured to obtain and enable access to different types of call destination information, such as, for example, information related to the geographic location of the call destination (e.g., weather or local news at the call destination), information related to the call recipient (e.g., online status of the call recipient or stock quotes or other information related to the company represented by the call recipient), and information related to the call recipient but proprietary to the caller or to an organization affiliated with the caller (e.g., private address book or calendar information related to the call recipient).

The call destination information system may deliver the call destination information to the caller phone over the telephone system. The call destination information may be provided as voice data over the caller phone before, during, or after the phone call. For example, the call destination information may be provided while the caller waits for the recipient at the destination to pick up the destination phone, or the call destination information may be whispered to the caller during the phone call.

The call destination information system also may deliver the call destination information to the caller computer system as one or more digital communications over the network. The digital communications may include e-mails sent through the e-mail system, instant messages sent through the IM system, and/or other messages or files sent directly from the call destination information system or through a digital communications messaging network.

The call destination information may be personalized to the caller by sending the call destination information only to callers that have registered for call destination information service. In some implementations, the call destination information may be further personalized by allowing the caller to choose which call destination information to receive by selecting a specific call destination service product composed of all or a subset of the call destination information types (e.g., a business-focused product, a home-use-focused product, or a travel-focused product). The call destination information also may be further personalized in that the call destination information system may access call recipient information that is personal to the caller or to an organization represented by the caller (i.e., proprietary call recipient information).

In another implementation, the call destination information system may receive the caller-related information and the destination telephone number from a monitoring device attached or coupled to the caller phone, rather than from the telephone system. The monitoring device monitors the line voltage on the phone line and directly or indirectly passes the destination telephone number and the caller-related information to the call destination information system over the network.

The communications system may be advantageously used in a variety of situations. For example, a caller may desire information about the latest events and stock quotes corresponding to a business when calling that business. Such information may enhance the quality of the conversation with a call recipient affiliated with the business.

In another example, a caller may call various retail stores to determine whether the retail stores carry a desired product. The caller may desire to automatically receive a map or directions from the caller location to the retail store, information related to the business hours of the store, and information related to the inventory for each store that is called. Such information can be used by the caller to facilitate the acquisition of a desired product.

In yet another example, a caller may want information about the weather or local news where a friend or business acquaintance (hereinafter “friend”) lives when calling that friend over the phone. A caller also may want information related to his or her friend that the caller has stored in an address book or in a calendar (e.g., the names of the members of the family of his or her friend or the dates of upcoming birthdays or events related to his or her friend). Such information is useful to the caller in that it offers the caller additional topics of conversation that may enrich the conversation between the caller and the friend.

In yet another example, a caller may want call recipient schedule or calendar information when the call is set up. The schedule information allows the caller to conveniently schedule meetings with the call recipient during the call, should the need for such a meeting suddenly arise.

In yet another example, a caller affiliated with a business may want to know information about a customer call recipient such as the history of products or services sold to the customer call recipient. This information allows the caller to increase the effectiveness of the call by personalizing the conversation.

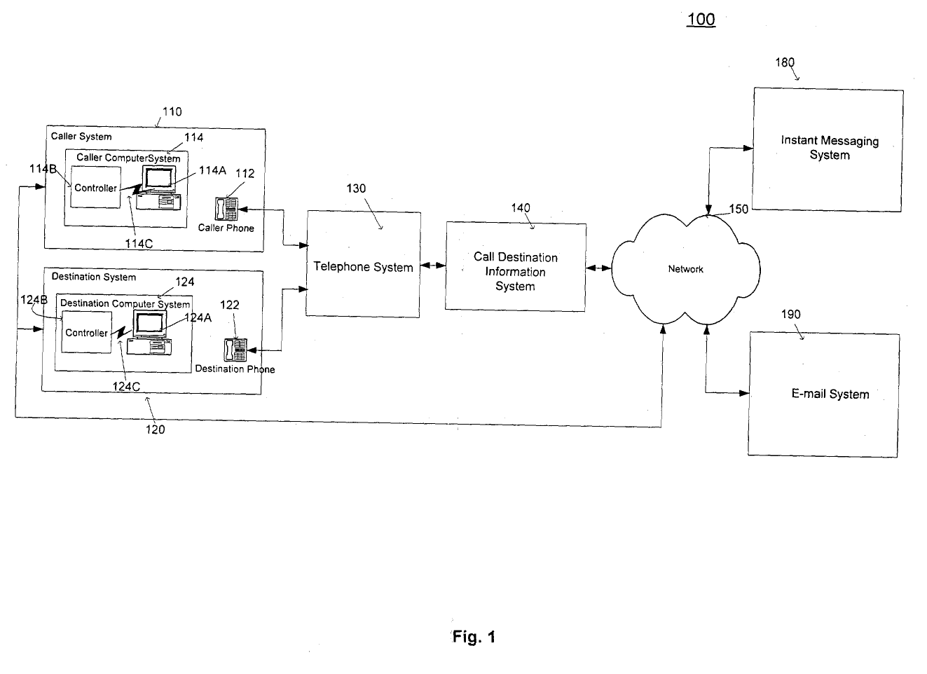

Referring to FIG. 1, a communications system 100 capable of providing call destination information to a caller includes a caller system 110 that is used to call a destination system 120 through a telephone system 130. The caller system 110 includes a caller phone 112 and a caller computer system 114. The destination system 120 includes a destination phone 122 and a destination computer system 124. The caller phone 112 may be associated with a caller telephone number, and the destination phone 122 may be associated with a destination telephone number.

The telephone system 130 is configured to communicate with a call destination information system 140 that provides call destination information to the caller. The call destination information system 140 is configured to provide call destination information through the telephone system 130 to the caller phone 112 and/or through a network 150 to the caller computer system 114. A recipient of the call may have access to the destination computer system 124 that is configured to communicate with the caller computer system 114.

The call destination information may be sent to the caller computer system 114 as digital communications. The digital communications may include instant messages (“IMs”) sent through an IM system 180, e-mails sent through an e-mail system 190, and/or other messages or files including audio data, video data, general binary data, or text data (e.g., encoded in the American Standard Code for Information Interchange (ASCII) format) sent directly from the call destination information system 140 or through a digital communications messaging network.

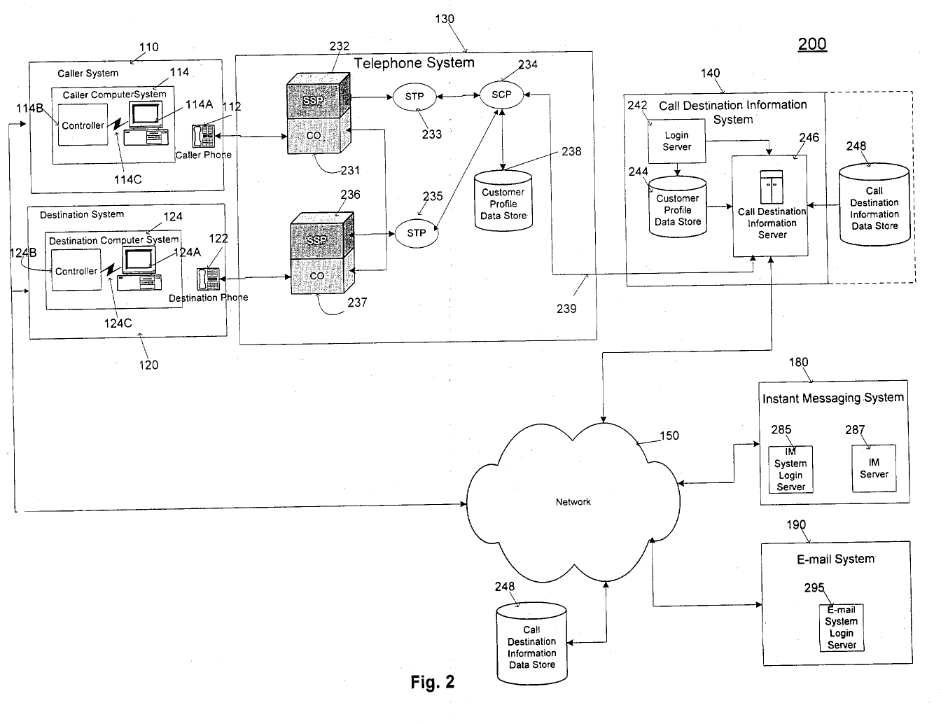

The caller phone 112 and the destination phone 122 may be landline phones that allow communications over the telephone system 130. In another implementation, the caller phone 112 and/or the destination phone 122 may be cellular phones or mobile personal digital assistants (PDAs) with embedded cellular phone technology. For ease of discussion, the telephone system 130 described below with respect to FIG. 2, assumes that the phones are landline phones. The telephone system 130, however, may be modified to support cellular phones by including cell-phone towers and associated telecommunications equipment in a corresponding manner to achieve the same or similar functionality as that described below.

The caller computer system 114 is configured to receive call destination information from the call destination information system 140 in the form of one or more digital communications, and to exchange digital communications with the destination computer system 124. The caller computer system 114 (or the destination computer system 124) includes a device 114A (or a device 124A) capable of executing instructions under the command of a controller 114B (or a controller 124B). The device 114A or the device 124A may be a general purpose computer, such as a workstation or a personal computer, a PDA, an intelligent mobile phone, a pager, or a set top box.

The controller 114B commands and directs communications between the device 114A of the caller computer system 114 and the call destination information system 140, the IM system 180, the e-mail system 190, and/or another messaging system configured to enable receipt of digital communications from the call destination information system 140. The controller 114A may be one or more software or hardware applications that enable digital communications to be received from the call destination information system 140. For example, in one implementation, the controller 114B may be an IM application configured to receive IMs from the IM system 180, an e-mail application configured to receive e-mails from the e-mail system 190, and/or a browser application configured to receive call destination data from the call destination information system 140. In another implementation, the controller 114B is an integrated application able to receive and process different kinds of messages including IMs, e-mails, and messages written in a markup language (such as Hypertext Markup Language (HTML), a standard generalized markup language (SGML), a dynamic HTML (DHTML), or an extensible markup language (XML)). In some implementations, the controller 114B includes a digital communications interface application that enables exchange of digital communications with the call destination information system 140 and the destination computer system 124 using a file transfer protocol.

The controller 124B may command and direct communications between the device 124A of the destination computer system 124 and the IM system 180, the e-mail system 190, and/or another digital communications system configured to allow the caller computer system 114 to exchange digital communications with the destination computer system 124. The controller 124B may be a digital communications interface application that enables exchange of digital communications with the caller computer system 114 using a file transfer protocol. For example, the digital communications interface may be an e-mail application and the file transfer protocol may be, for example, Post Office Protocol (POP) or Internet Message Access Protocol (IMAP). Additionally or alternatively, the digital communications interface may be an IM application that allows the caller computer system 114 and the destination computer system 124 to exchange IMs.

The device 114A (or the device 124A) may be connected to the controller 114B (or the controller 124B) by a wired or wireless data pathway 114C (or pathway 124C) capable of delivering data. In one implementation, the communications system 100 does not include the caller computer system 114. In another implementation, the communications system 100 does not include the destination computer system 124. In yet another implementation, the communications system 100 does not include either a caller computer system 114 or a destination computer system 124.

Referring to FIG. 2, one particular implementation of a communications system 200 is illustrated to show the structure generally included with respect to the communications system 100 of FIG. 1. In fact, using the structure and organization shown by FIG. 1, FIG. 2 provides an illustration of systems that may be used to implement each of telephone system 130, call destination information system 140, IM system 180 and email system 190.

The telephone system 130 of FIG. 2 includes an originating service switching point (SSP) 232 located in an originating central office 231 that provides telephone services to the caller phone 112. The SSP 232 is configured to collect the destination telephone number dialed by the caller using the caller phone 112 and to send the collected destination telephone number and caller-related information to a switching control point (SCP) 234 through a signal transfer point (STP) 233. The caller-related information may include, for example, the phone number corresponding to the caller phone 112. The SCP 234 is configured to receive the destination telephone number and the caller-related information and to use the caller-related information to retrieve customer service information for the caller from a customer profile data store 238. The customer service information includes information related to the services that the caller currently is receiving through the telephone system 130. For instance, the SCP 234 is configured to determine whether the caller has registered for call destination information service based on the retrieved customer service information. If the caller has not registered for call destination information service, the SCP 234 need not communicate with the system 140.

If, however, the caller has registered for call destination information service, the SCP 234 is configured to send the caller-related information and the destination telephone number to the call destination information system 140 over a communications link 239. The communications link 239 may be implemented using any permanent or temporary communications link configured to transfer the caller-related information and the destination telephone number (e.g., a communications medium configured to transfer data signals as electrical, electromagnetic, or optical waves). Although not shown, in another implementation, the caller-related information and the destination telephone number are sent to the call destination information system 140 over network 150.

Concurrent, subsequent, or prior to sending the caller-related information and the destination telephone number to the system 140, the SCP 234 is configured to send an authorization signal to the SSP 232 that instructs/authorizes SSP 232 to proceed with setting up the call. After receiving the authorization signal, the SSP 232 communicates with a destination SSP 236 through a STP 235 in order to complete setting up the call. The destination SSP 236 may be located in a destination central office 237 that provides telephone services to the destination phone 122.

The customer profile data store 238 includes one or more data storage devices configured to store information related to customers receiving telecommunications services from the telephone system 130. The information may include customer service information and other general information collected during service registration (e.g., e-mail address, phone number, and home address).

The call destination information system 140 includes a login server 242, a customer profile data store 244, and a call destination information server 246. To enable a caller to receive call destination information at the caller system 110, the login server 242 of the call destination information system 140 may receive access information from/concerning the caller system 110 through a registration process or otherwise. The access information may include, for example, a customer identifier and a password.

Once the caller logs into the call destination information system 140, the call destination information server 246 may subsequently push or otherwise make accessible to the caller call destination information. One or more digital communications used for this purpose may be accessible through, for example, a web browser application, an instant message (IM) application, or an e-mail application. The call destination information server 246 may determine whether the caller is online to receive e-mails or IMs by determining an online identity of the caller and requesting the login status of the online identity from an IM server 287 of the IM system 180 and/or from a login server 295 of the e-mail system 190. If the caller has logged into the IM system 180 or the e-mail system 190, then the caller is available to receive IMs or e-mails. In some implementations, e-mails containing call destination information are sent regardless of whether the caller is online and ready to promptly perceive the e-mails.

The online identity of the caller may be, for example, a screen name, an IM handle, an e-mail address, and/or an Internet Protocol (IP) address. The online identity may be determined, for example, by using the customer identifier to access a customer profile record stored in the customer profile data store 244. Furthermore, the caller may provide the online identity during the registration process for the call destination information service.

In another implementation, the call destination information system 140 does not include a login server 242 and instead determines the online status of the caller and availability to receive call destination information at the caller computer system 114 by determining the online identity of the caller and subsequently accessing the IM server 287, the e-mail login server 295, and/or an Internet Service Provider (ISP) login server (not shown). In this implementation, the online identity of the caller is determined by the call destination information server 246 based on the caller-related information received from the telephone system 130. The caller-related information (e.g., caller telephone number) may be used to access a customer profile record that includes the online identity of the caller from within the customer profile data store 244.

In yet another implementation, the call destination information system 140 and one or more of the IM system 180 and the email system 190 are integrated into one system that has one login server, and call destination information is pushed to the caller in IMs and/or emails. For instance, the call destination information system 140, the IM system 180, and the e-mail system 190 are integrated into one Online Service Provider (OSP) system that has one login server, and call destination information is pushed or otherwise made accessible to the caller in IMs, e-mails, and/or through a web browser application.

The customer profile data store 244 includes one or more data storage devices configured to store information related to customers/callers receiving call destination information services from the call destination information system 140. The customer profile data store 244 may include customer profile records having information related to the caller, the caller phone 112, and/or the caller computer system 114. The information related to the caller may include the name of the caller, the address of the caller, the online identity of the caller, and the preferred method of receiving call destination information (e.g., by phone, IM, e-mail, or through a web browser application). The information related to the caller phone 112 may include the phone number and the functional capabilities of the phone (e.g., Internet access and e-mail/IM capability of PDA phones). The information related to the caller computer system 114 may include the hardware specifications of the system (e.g., processor, memory space, and graphics capability), the mode of network access (e.g., dial-up, xDSL, cable, or T1), and the peripherals (e.g., scanners and printers). The information related to the caller, the caller phone 112, and the caller computer system 114 may be accessed by the call destination information server 246 when determining the type, quantity, and delivery method of the call destination information that may be sent to the caller (e.g., the call destination information server 246 may send a relatively small amount of information over a narrowband connection and a relatively large amount of information, including relatively enhanced graphics, over a broadband connection). The caller may provide information related to the caller, the caller phone 112, and the caller computer system 114 during the call destination information service registration process.

The customer profile records in the customer profile data store 244 also may include information related to the types of call destination information services that the caller is registered to receive. As discussed next, the call destination information server 246 may access various types of call destination information (e.g., geographic-based information, call recipient-based information, and proprietary call recipient information).

The operator of the call destination information system 140 may create multiple service products by packaging different subsets of the various types of call destination information available to the call destination information server 246. For example, a business product may be offered that provides the caller with publicly available information related to businesses corresponding to the destination telephone numbers (e.g., stock quotes and financial information). A personal home product may be offered that provides the caller with caller address book or calendar information related to call recipients corresponding to the destination telephone numbers (e.g., social engagement dates associated with the call recipient, name of family members of the call recipient, and birthday dates associated with the call recipient). A travel product may be offered that provides the caller with weather at the call destination and/or a map or directions from the caller to the call destination.

In one implementation, the customer profile records include one or more flags (e.g., bits) that correspond to the different call destination information products available to the caller. The call destination information server 246 may determine which information to access and send to the caller based on the one or more flags in the customer profile records. For example, if a flag is set to ON, the caller is registered to receive a corresponding call destination information product, and the call destination information server 246 accesses and sends information related to that product to the caller. If, however, the flag is set to OFF, the caller is not registered to receive the corresponding call destination information product, and the call destination information server 246 need not access and send information related to that product to the caller.

In another implementation, call recipients may specify information that they want made available to general callers or to specific callers through the call destination information system 140. Additionally or alternatively, call recipients may specify information that they want blocked from general callers or from specific callers. Call recipient preferences may be stored in call recipient data records in a data store accessible to the call destination information server 246 (e.g., in the customer profile data store 244 or in the customer profile data store 238). The call destination information server 246 may access the call recipient data records concurrent, subsequent, or prior to accessing the customer profile records and prior to providing the caller with access to the call destination information. The call destination information server 246 may filter call destination information and/or provide additional call destination information based on the call recipient data records.

In another implementation, the customer profile data store 244 and the customer profile data store 238 are integrated into one data store. In this implementation, the integrated data store includes customer-level information related to call destination information services received from the call destination information system 140 and telecommunications services received from the telephone system 130. The integrated data store may be directly or indirectly accessible to the call destination information server 246 and the SCP 234.

The call destination information server 246 includes one or more servers, processors, or intelligent devices configured to communicate with the SCP 234, access call destination information from local and/or remote sources, and provide the call destination information to the caller phone 112 and/or to the caller computer system 114. The call destination information server 246 is configured to receive call destination information from one or more of the following sources: the telephone system 130, one or more destination information data stores 248, the caller system 110, the IM system 180, and the e-mail system 190. The call destination information server 246 may access the customer profile data store 244 to determine the call destination information products that the caller is registered to receive. The call destination information products that the caller is registered to receive affect the type and quantity of information that is accessed by the call destination information server 246.

The call destination information server 246 may be configured to retrieve call destination information from the telephone system 130. In one implementation, the server 246 is configured to retrieve call destination information from the SCP 234, which may retrieve the call destination information from the customer profile data store 238 or from another accessible data store (e.g., a directory data store). The SCP 234 may retrieve call destination information based on the destination telephone number or based on other call destination-related information provided by the server 246. The call destination information that may be provided by the telephone system 130 may include, for example, the name and address of the recipient of the call and the history of phone calls that the caller has made to the destination telephone number.

The call destination information server 246 also may be configured to retrieve call destination information from the one or more call destination information data stores 248. The call destination information data stores 248 may be local to the call destination information system 140 or remote from the call destination information system 140 but accessible over the network 150. The call destination information data stores 248 include data storage devices that may be standalone devices or part of larger computer systems that are configured to allow the call destination information server 246 to directly or indirectly access the data storage devices. The call destination information data stores 248 may be indexed based on the destination telephone number or based on other data related to the call recipient (e.g., a name or address of the recipient, an online identity, a customer identity, or another recipient identifier). In one implementation, the call destination information data stores 248 are part of computer systems of content service providers otherwise unaffiliated with the call destination information system 140 or service provider.

The call destination information server 246 may be configured to retrieve different types of call destination information. The types of call destination information may include information related to the geographic location of the call destination (i.e., geographic-based information), information related to the call recipient (i.e., call recipient-based information), and information related to the call recipient but proprietary to the caller or to an organization affiliated with the caller.

The call destination information server 246 may be configured to retrieve geographic-based information from the call destination information data stores 248. The geographic-based information may include, for example, the weather at the call destination, the local news of the call destination, and/or a map or directions from the caller to the call recipient. The map or directions may be determined based on the address of the recipient (derived from the destination telephone number) and the address of the caller (obtained using the telephone number of the caller to access the customer profile data store 238, the customer profile data store 246, or a directory data store). In another implementation, the telephone system 130 services mobile cellular phones and provides dynamic call destination location information to the call destination information server 246. The dynamic call destination location information may be used to access the data stores 248 to obtain geographic-based information.

The call destination information server 246 also may be configured to retrieve call recipient-based information from the call destination information data stores 248. If the call recipient is a representative of a company or business, the call recipient-based information may include, for example, news related to the latest or upcoming activities of the company, the latest stock quotes of the company, or other information related to the company (e.g., financial information, size of company, product information, services available, upcoming business events, latest information about the company appearing in a publication, or industry sector information). If the call recipient is a representative of an organization (e.g., a nonprofit organization, a church, or a government organization or agency), the call recipient-based information may include, for example, schedules of events, procedural information related to services, events, or products offered by the organization, and/or membership information. If the call recipient is an individual, the call recipient-based information may include, for example, information related to the services received by the individual, products sold to the individual, or general information made available to general callers or to specific callers by the call recipient or by another entity (e.g., demographic information).

The call recipient-based information also may include the online status of the call recipient. The call destination information server 246 may determine the online status of the call recipient in a manner corresponding to that discussed above with respect to the determination of the online status of the caller. Additionally or alternatively, the call destination information server 246 may determine the online status of the call recipient by requesting the online status of the recipient from, for example, the login server 242 of the call destination information system 140, and/or a login server of an ISP. The call destination information server 246 may provide to the caller the online status of the call recipient and information related to the corresponding ability of the call recipient to receive IMs, promptly receive e-mails, and/or receive other digital communications from the caller.

The call destination information server 246 also may be configured to retrieve call recipient information that is proprietary to the caller or to a business or organization associated with the caller (e.g., the workplace of the caller). The proprietary call recipient information may be retrieved from the caller system 110 or from one or more call destination information data stores 248 positioned locally or remotely to the caller system 110. The call destination information data stores 248 may be data stores accessible to the caller system 110 and/or data stores integrated with or accessible to a computer system supporting the caller, the caller system 110 (e.g., a business platform system supporting the caller system 110), and/or the organization associated with the caller. The proprietary call recipient information may include, for example, proprietary address book information related to the call recipient, business-related information specific to interactions with the call recipient (e.g., billing data, service data, and products or services sold to the call recipient or to a company or organization associated with the call recipient), or other proprietary information related to the call recipient (e.g., birthday dates, anniversary dates, social engagement dates, travel dates, or availability information from a calendar). In one implementation, address book information and calendar information related to the call recipient are obtained from the caller system 110 by the call destination information server 246. In another implementation, this information is obtained from a call destination information data store 248 located in or accessible through a host system providing communications services to the caller system 110.

In one implementation, the call destination server 246 may use the online identity of the caller and the recipient to access proprietary call recipient information related to e-mails sent to the caller by the call recipient or to the call recipient by the caller (e.g., e-mail header data and/or e-mail body data). The e-mail information may be stored in one or more data records corresponding to the online identity of the caller and located in a mailbox system of an e-mail system 180 that offers e-mail services to the caller. Additionally or alternatively, the e-mail information may be stored locally at the caller system 110. The caller may provide e-mail address and access information (e.g., password information) that may be stored in the customer profile data store 246 and used by the call destination computer to access the mailbox of the caller. The call destination server 246 may retrieve only those e-mails in the mailbox of the caller related to the call recipient by, for example, using the filtering abilities available to a typical user of the e-mail system 180 in an automated manner or by extracting header information of all the e-mails and performing filtering logic at the call destination server 246 prior to selective retrieval of the rest or other portions of the e-mails. The call destination server 246 may communicate with the e-mail system 180 using, for example, Post Office Protocol (POP) or Internet Message Access Protocol (IMAP).

The call destination server 246 may be configured to provide call destination information to the caller computer system 114 over the network 150. The call destination server 246 may push or otherwise make accessible the call destination information to the caller computer system 114 as digital communications. For example, the call destination server 246 may push the call destination information to the caller computer system 114 as one or more IMs, as one or more e-mails, or through a web browser application (depending on the preferences of the caller and/or the online status of the caller). In another example, the call destination server 246 may indirectly provide call destination information to the caller computer system 114 by communicating with another computer system and authorizing that computer system to send call destination information to the caller system computer system 114. The call destination information may be provided during the phone call and/or after the phone call.

Additionally or alternatively, the call destination server 246 may be configured to provide the call destination information to the caller phone 112 over the telephone network 130. In this implementation, the call destination information system 140 may include a voice gateway (not shown) connected to the telephone network 130 that injects voice destination information data into the call over the telephone network 130. The injection of destination information into the call is possible by configuring the telephone network 130 to include call processing architecture similar to that employed for handling pre-paid calling cards or voice recognition services (i.e., a central server routes and continuously monitors the phone call). The call destination information may be provided through voice over the caller phone before, during, or after the phone call. For example, the call destination information may be provided while the caller waits for the recipient at the destination to pick up the destination phone 122, or the call destination information may be whispered to the caller during the phone call (i.e., spoken to the caller using a voice that is not heard by the call recipient and that is lower in volume than the voice of the call recipient).

The network 150 is configured to enable direct or indirect communications between the caller system 110, the destination system 120, the call destination information system 140, the IM system 180, the mail system 190, and one or more call destination information data stores 248. Examples of a network 150 include the Internet, Wide Area Networks (WANs), Local Area Networks (LANs), analog or digital wired and wireless telephone networks (e.g., Public Switched Telephone Network (PSTN), Integrated Services Digital Network (ISDN), and Digital Subscriber Line (xDSL)), radio, television, cable, satellite, and/or any other delivery or tunneling mechanism for carrying data.

The IM system 180 is a computer system that allows the exchange of IMs between various client systems including one or more of the caller computer system 114, the destination computer system 124, and, in some implementations, the call destination information system 140. In one particular implementation example, the IM system 180 may include a login server 285 that typically determines whether a particular user or entity (e.g., a computer system) is authorized to access the IM system 180 by verifying a subscriber identification (i.e., online identity) and password. If the user or entity is authorized to access the IM system 180, the login server 285 employs a hashing technique on the subscriber identification to identify a particular IM server 287 for use during the user's or entity's session. The login server 285 provides the client system with the IP address of the particular IM server 287, gives the client system an encrypted key (i.e., a cookie), and breaks the connection. The client system then uses the IP address to establish a connection to the particular IM server through network 150, and obtains access to that IM server 287 using the encrypted key. Typically, the client system will be equipped with a Winsock API (“Application Programming Interface”) that enables the client system to establish an open TCP (“Transmission Control Protocol”) connection to the IM server 287. Once a connection to the IM server 287 is established, the client system may directly or indirectly transmit data to and access content from the IM server 287. The IM server 287 supports fundamental instant messaging services including the exchange of IMs between users or entities and the determination of the online status of particular users or entities. In another implementation example, IMs are communicated through one or more centralized IM servers 287.

The e-mail system 190 is a computer system that allows the exchange of e-mails between various client systems including one or more of the caller system 110, the destination system 120, and, in some implementations, the call destination information system 140. In one particular implementation example, the e-mail system includes a login server 295 that typically determines whether a particular user or entity is authorized to access the e-mail system 190 by verifying a subscriber identification (i.e., online identity) and password. If the user of a client system is authorized to access the e-mail system 190, the login server allows the user or entity to access the e-mail services provided by the e-mail system 190. The e-mail services include retrieving e-mails from a user/entity mailbox and sending e-mails to other users/entities. The login server 295 may keep track of the users or entities that are currently logged into the e-mail system 290 and may be configured to provide this information for selected users or entities to the call destination information system 140.

In some implementations, the communications system 100 does not include one or both of the IM system 180 or the e-mail system 190.

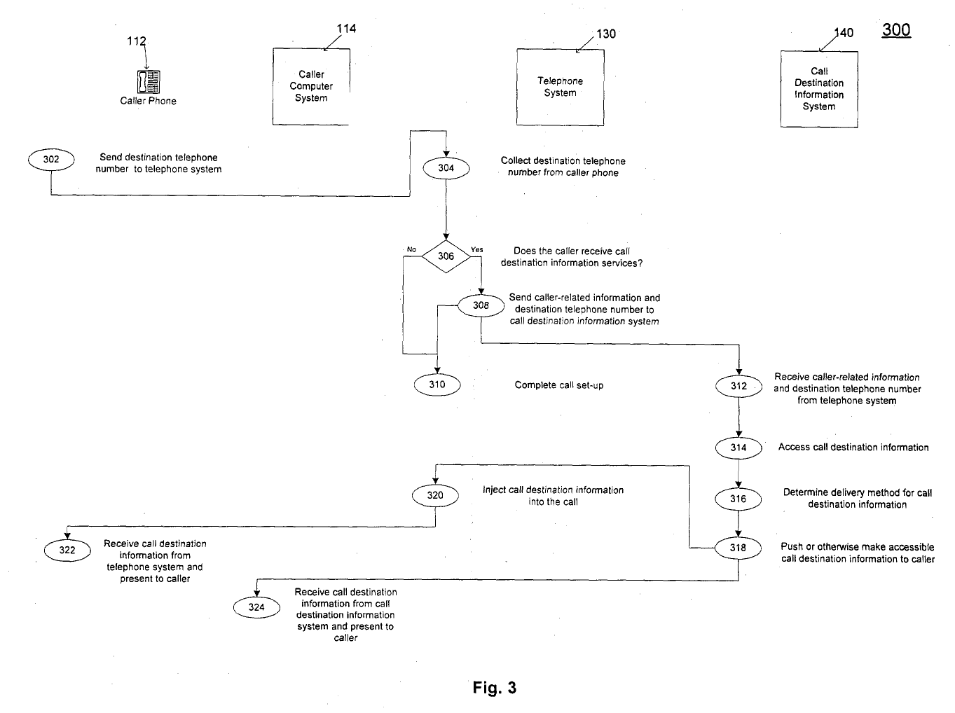

FIG. 3 shows a process 300 for providing call destination information to a caller. For convenience, the process 300 shown in FIG. 3 references particular componentry described with respect to FIG. 1. However, similar methodologies may be applied in other implementations where different componentry is used to define the structure of the system, or where the functionality is distributed differently among the components shown by FIG. 1.

The caller dials a destination telephone number using the caller phone 112 (302). The destination telephone number is sent to the telephone system 130, which receives the destination telephone number from the caller phone (304) and accesses customer service information corresponding to the caller to determine whether the caller receives destination information services (306). For instance, the telephone system 130 may access customer service information corresponding to the caller from the customer profile data store 238 based on caller-related information (such as the telephone number corresponding to the caller phone 112). If the caller is not registered to receive call destination information services, then the telephone system 130 simply completes the call set up (310). If the caller is not registered to receive call destination information services, the telephone system 130 simply completes the call set up (308).

If the caller is registered to receive call destination information services, the telephone system 130, in addition to completing the call set up (310), sends caller-related information and the destination telephone number to the call destination information system 140 (310). The call destination information system 140 receives the caller-related information and the destination telephone number from the telephone system (312) and accesses appropriate call destination information (314). For instance, in one implementation, the call destination information server 246 of the call destination information system 140 accesses the customer profile data store 244 to determine the call destination service product(s) that the caller is registered to receive. Based on these product(s), the call destination information server 246 accesses call destination information from various sources as discussed previously.

The call destination information system 140 may access geographic-based information such as, for example, a map or directions from the caller to the call recipient or the weather or local news at the geographic location of the destination phone. The call destination information system 140 also may access call recipient-based information. The call recipient-based information may include information related to a company represented by the call recipient such as, for example, stock quotes of the company or news related to the activities of the company. The call recipient-based information also may include information related to the online status of the call recipient or information related to services provided to the call recipient or products sold to the call recipient. The information related to the online status of the call recipient may include information related to the ability of the call recipient to receive e-mails or to receive instant messages.

The call destination information system 140 may access call recipient information that is proprietary to the caller or to a business or an organization related to the caller. The proprietary call recipient information may include proprietary address book information related to the call recipient, proprietary calendar information related to the call recipient, proprietary information related to business interactions between the call recipient and the caller or between the call recipient and a business or an organization associated with the caller, proprietary information related to products or services sold to the call recipient or sold to an organization or business associated with the call recipient, and proprietary information related to e-mails sent to the call recipient by the caller or received by the caller from the call recipient.

The call destination information system 140 may access information designated by the call recipient as information that is available to the caller. The call destination information system 140 may not access information designated by the call recipient as information that is blocked to the caller.

After accessing the call destination information (314), the call destination information system 140 determines the delivery method used to push or otherwise make accessible the call destination information to the caller system 110 (316). The delivery methods may include sending the call destination information to the caller phone 112 using the telephone system 130 and sending the call destination information over the network 150 to the caller computer system 114. The choice of which method to use may depend on the online status of the caller and/or the information related to the caller, the caller phone 112, and the caller computer system 114 stored in the customer profile data store 244. The call destination information system 140 also may determine parameters related to the delivery, such as the type and quantity of call destination information that may be sent to the caller (e.g., video may be sent over a broadband connection). In some implementations, the determination of the delivery method (316) may occur concurrent or prior to retrieving the call destination information (314).

The call destination information system 140 then pushes or otherwise provides the caller with access to the call destination information (318). In one implementation, the call destination information server 246 of the call destination information system 140 retrieves and stores the call destination information and then makes the call destination information accessible to the caller all at once through the caller computer system 114 and/or through the caller phone 112. In another implementation, the call destination information server 246 dynamically provides the call destination information to the caller as the call destination information is received or accessed by the call destination information server 246. In yet another implementation, the call destination information server 246 indirectly provides call destination information to the caller computer system 114 and/or to the caller phone 112 by communicating with another computer system and authorizing that computer system to send call destination information to the caller computer system 114 and/or to the caller phone 112.

The telephone system 130 injects call destination information into the call (320), and the call destination information subsequently is presented to the caller over the caller phone 112 (322). Additionally or alternatively, the caller computer system 114 may receive the call destination information and present the call destination information to the caller (324) concurrent with or subsequent to the phone call.

A number of implementations have been described. Nevertheless, it will be understood that various modifications may be made. For example, the controllers 114B and 124B may include a program, a piece of code, an instruction, a device, a computer, a computer system, or a combination thereof, for independently or collectively directing the respective devices 112A and 122A to interact and operate as described. The controllers 114B and 124B may be embodied permanently or temporarily in any type of machine, component, physical or virtual equipment, storage medium, or propagated signal capable of providing instructions to the devices 114 and 124. The call destination information system 140, the IM system 180, and the e-mail system 190 may provide the described functionality using a different configuration of hardware or software working in concert with one or more other systems, such as, for example, one or more LANs or WANs.

The call destination information server 246 may receive caller-related information and the destination telephone number from a monitoring device attached or otherwise coupled to the caller phone 112. The monitoring device monitors the line voltage on the phone line and passes the destination telephone number and associated caller-related information to the call destination information server 246 over the network 150. Alternatively, the monitoring device may monitor the line voltage of the phone line and send the destination telephone number to the caller computer system 114, which, in turn, sends the caller related data and destination telephone number to the call destination information server 246. The monitoring device may be implemented using a caller ID adapter similar to the ANI-232 available from Rochelle Communications Inc. The monitoring device allows the call destination information system 140 to provide call destination information to the caller at the caller computer system 114 without having to communicate or otherwise interact with the telephone system 130.

In another implementation, the caller phone 112 includes data capabilities and display devices appropriate for receipt of call destination information and corresponding to the functionality of the device 114A, controller 114B, and/or link 114C as described above with respect to the caller computer system 114.

In yet another implementation, the caller phone 112 and/or the destination phone 122 are data phones (e.g., Ethernet phones) and the telephone system 130 is replaced by a Voice over Internet Protocol (VoIP) system that may or may not be integrated into the network 150. The VoIP system allows calls to originate or terminate as IP data and then either terminates or originates on a telephone system (e.g., the Public Switched Telephone Network), with IP conversion occurring somewhere in the process. The VoIP system may include servers configured to operate as soft or IP Private Branch Exchanges (PBXs). The VoIP system performs functions that correspond to those performed by the telephone system 130 completely or partially over a packet-switched IP-based data network rather than over a circuit-switched telephone network. By performing call set up and routing over a data network, the VoIP system allows greater integration between voice-related processing and the data processing associated with the provision of call destination information to the caller.

In some implementations, the caller-related information includes caller identity information in place of or in addition to the caller telephone number. Caller identity information may be used to identify and distinguish a specific caller from other callers that use the same caller phone 112 (e.g., when the caller phone 112 is a public phone or a family phone). The caller may directly or indirectly provide caller identity information concurrent, prior, or subsequent to initiating the call (e.g., the user may input a Personal Identification Number (PIN) using the caller phone 112 prior to inputting the destination telephone number).

Accordingly, other implementations are within the scope of the following claims.

What is claimed is:

1. A method for providing call destination information to a caller, the method comprising:
receiving information related to a caller that uses a caller phone to make a call to a destination phone;
receiving information related to a call recipient that uses the destination phone to receive the call;
accessing call destination information based on both the information related to the caller and the information related to the call recipient; and
providing the caller with access to the call destination information.

2. The method of claim 1, wherein accessing call destination information includes accessing information regarding the call destination that is personalized to the caller based on the information related to the caller.

3. The method of claim 2, wherein the call destination information that is personalized to the caller is only accessed for to callers that have registered for a call destination information service.

4. The method of claim 2, wherein the call destination information is personalized to the caller by including call destination information corresponding to a call destination service product chosen by the caller.

5. The method of claim 2, wherein the call destination information is personalized to the caller by providing the caller with access to call destination information that is personal to the caller or to an organization represented by the caller.

6. The method of claim 1, wherein the information related to a call recipient includes a destination telephone number associated with the destination phone.

7. The method of claim 1, wherein the information related to a caller includes a caller telephone number associated with the caller phone.

8. The method of claim 1, wherein the information related to the caller is received from a telephone system.

9. The method of claim 1, wherein the information related to the caller is received from a monitoring device coupled to the caller phone.

10. The method of claim 1, wherein the call destination information that is accessed includes information related to the geographic location of the destination phone.

11. The method of claim 10, wherein the call destination information that is accessed includes the weather or local news at the geographic location of the destination phone.

12. The method of claim 10, wherein the call destination information that is accessed includes a map or directions from the caller to the call recipient.

13. The method of claim 1, wherein the call destination information that is accessed includes information related to the call recipient.

14. The method of claim 13, wherein the call destination information that is accessed includes information related to a company represented by the call recipient.

15. The method of claim 14, wherein the call destination information that is accessed includes stock quotes of the company or news related to the activities of the company.

16. The method of claim 13, wherein the call destination information that is accessed includes information related to services provided to the call recipient or products sold to the call recipient.

17. The method of claim 13, wherein the call destination information that is accessed includes information designated by the call recipient as information that is available to the caller.

18. The method of claim 13, wherein the call destination information that is accessed does not include information designated by the call recipient as information that is blocked to the caller.

19. The method of claim 13, wherein the call destination information that is accessed includes information related to the online status of the call recipient.

20. The method of claim 19, wherein the online status information that is accessed includes information related to the ability of the call recipient to receive e-mails.

21. The method of claim 19, wherein the online status information that is accessed includes information related to the ability of the call recipient to receive instant messages.

22. The method of claim 13, wherein the call destination information that is accessed includes call recipient information that is proprietary to the caller or to a business or an organization related to the caller.

23. The method of claim 22, wherein the proprietary call recipient information includes proprietary address book information related to the call recipient.

24. The method of claim 22, wherein the proprietary call recipient information includes proprietary calendar information related to the call recipient.

25. The method of claim 22, wherein the proprietary call recipient information includes proprietary information related to business interactions between the call recipient and the caller or between the call recipient and a business or an organization associated with the caller.

26. The method of claim 25, wherein the proprietary call recipient information includes proprietary information related to products or services sold to the call recipient or sold to an organization or business associated with the call recipient.

27. The method of claim 22, wherein the proprietary call recipient information includes information related to e-mails sent to the call recipient by the caller or received by the caller from the call recipient.

28. The method of claim 1, wherein providing the caller with access to the call destination information includes sending call destination information to the caller as one or more digital communications accessible to the caller through a caller computer system.

29. The method of claim 28, wherein the digital communications comprise e-malls.

30. The method of claim 28, wherein the digital communications comprise instant messages.

31. The method of claim 28, wherein the digital communications are accessible using a browser application.

32. The method of claim 28, wherein the digital communications are sent during the call.

33. The method of claim 28, wherein the digital communications are sent after the call.

34. The method of claim 1, wherein providing the caller with access to the call destination information includes sending call destination information to the caller as data over the caller phone.

35. The method of claim 34, wherein the call destination information is provided to the caller while the caller waits for a call recipient to pick up the destination phone.

36. The method of claim 34, wherein the call destination information is whispered to the caller during the call.

37. A call destination information computer system for providing call destination information to a caller, the computer system comprising:
one or more call destination information data stores configured to store call destination information; and
a call destination information computer configured to
receive information related to a caller that uses a caller phone to make a call to a destination phone,
receive information related to a call recipient that uses the destination phone to receive the call;
access call destination information from at least one of the call destination information data stores based on both the information related to the caller and the information related to the call recipient, and
provide the caller with access to the call destination information.

38. The system of claim 37, wherein the call destination information computer is configured to access call destination information that includes information regarding the call destination that is personalized to the caller based on the information related to the caller.

39. The system of claim 37, wherein the call destination information computer is configured to access call destination information that includes information related to the geographic location of the destination phone.

40. The system of claim 37, wherein the call destination information computer is configured to access call destination information that includes information related to the call recipient.

41. The system of claim 40, wherein the call destination information computer is configured to access call destination information that includes information designated by the call recipient as information that is available to the caller.

42. The system of claim 40, wherein the call destination information computer is configured to access call destination information that does not include information designated by the call recipient as information that is blocked to the caller.

43. The system of claim 40, wherein the call destination information computer is configured to access call destination information that includes information related to the online status of the call recipient.

44. The system of claim 40, wherein the call destination information computer is configured to access call destination information that includes call recipient information that is proprietary to the caller or to a business or an organization related to the caller.

45. The system of claim 37, wherein the call destination information computer is configured to provide the caller with access to the call destination information by sending call destination information to the caller as one or more digital communications accessible to the caller through a caller computer system.

46. The system of claim 45, wherein the digital communications comprise e-mails.

47. The system of claim 45, wherein the digital communications comprise instant messages.

48. The system of claim 37, wherein the call destination information computer is configured to provide the caller with access to the call destination information by sending call destination information to the caller as data over the caller phone.

49. A computer system comprising:
a caller module configured to discern among callers calling a destination based on caller-related information; and
an information procurement module configured to provide a first discerned caller with access to a first set of call destination information and provide a second discerned caller with access to a second set of call destination information, the second set being different than the first set.

50. The system of claim 49, wherein the first set of call destination information is personalized to the first discerned caller.

51. The system of claim 49, wherein the first set of call destination information includes information related to the geographic location of the destination.

52. The system of claim 49, wherein the first set of call destination information includes information related to a call recipient at the destination.

53. The system of claim 52, wherein the first set of call destination information includes information designated by a call recipient at the destination as information that is available to the caller.

54. The system of claim 52, wherein the first set of call destination information does not include information designated by a call recipient at the destination as information that is blocked to the caller.

55. The system of claim 52, wherein the first set of call destination information includes information related to online status of a call recipient at the destination.

56. The system of claim 52, wherein the first set of call destination information includes call recipient information that is proprietary to the first discerned caller or proprietary to a business or an organization related to the first discerned caller.

57. The system of claim 49, wherein the information procurement module is configured to provide the first discerned caller with access to the first set of call destination information by sending call destination information to the first discerned caller as one or more digital communications accessible to the first discerned caller through a caller computer system.

58. The system of claim 57, wherein the digital communications comprise e-mails.

59. The system of claim 57, wherein the digital communications comprise instant messages.

60. The system of claim 49, wherein the information procurement module is configured to provide the first discerned caller with access to the first set of call destination information by sending call destination information to the first discerned caller as data over a caller phone used by the first discerned caller to call the destination.

61. A method for providing call destination information, the method comprising:
discerning among callers calling a destination based on caller-related information;
providing a first discerned caller with access to a first set of call destination information; and
providing a second discerned caller with access to a second set of call destination information, the second set being different than the first set.

62. The method of claim 61, wherein providing a first set of call destination information includes providing a first set of call destination information personalized to the first discerned caller.

63. The method of claim 61, wherein providing a first set of call destination information includes providing information related to the geographic location of the destination.

64. The method of claim 61, wherein providing a first set of call destination information includes providing information related to a call recipient at the destination.

65. The method of claim 64, wherein providing a first set of call destination information includes providing information designated by a call recipient at the destination as information that is available to the caller.

66. The method of claim 64, wherein providing a first set of call destination information does not include providing information designated by a call recipient at the destination as information that is blocked to the caller.

67. The method of claim 64, wherein providing a first set of call destination information includes providing information related to online status of a call recipient at the destination.

68. The method of claim 64, wherein providing a first set of call destination information includes providing call recipient information that is proprietary to the first discerned caller or proprietary to a business or an organization related to the first discerned caller.

69. The method of claim 61, wherein providing the first discerned caller with access to the first set of call destination information includes sending call destination information to the first discerned caller as one or more digital communications accessible to the first discerned caller through a caller computer system.

70. The method of claim 69, wherein sending call destination information to the first discerned caller includes sending call destination information as e-mails accessible to the first discerned caller.

71. The method of claim 69, wherein sending call destination information to the first discerned caller includes sending call destination information as instant messages accessible to the first discerned caller.

72. The method of claim 71, wherein providing a first discerned caller with access to the first set of call destination information includes sending call destination information to the first discerned caller as data over a caller phone used by the first discerned caller to call the destination.
